(19) United States
(12) Patent Application Publication
(10) Pub. No.: US 2026/0365107 A1
(43) Pub. Date: Nov. 19, 2026

(54) Motion Detection System for a Motor Vehicle

(71) Applicant: Bayerische Motoren Werke Aktiengesellschaft, Muenchen (DE)

(72) Inventors: David HEARN, Garching bei Muenchen (DE); David KRAGL, Zolling (DE); Stephan LUDWIG, Muenchen (DE); Benjamin SCHUSTER, Muenchen (DE); Marcel SIEBER, Muenchen (DE)

(21) Appl. No.: 19/130,164

(22) PCT Filed: Nov. 13, 2023
(86) PCT No.: PCT/EP2023/081631

§ 371 Date: May 15, 2025

(30) Foreign Application Priority Data
Nov. 16, 2022 (DE) 10 2022 130 324.1

(51) Int. Cl. B60Q 5/00; G06V 20/58

(52) U.S. Cl. CPC B60Q 5/005; G06V 20/58

(57) ABSTRACT

A motion detection system for a parking motor vehicle has a motion sensor which is configured to detect a movement of the parking motor vehicle, and a control device which is coupled to the motion sensor and is configured to output a control signal if a movement of the parking motor vehicle has been detected by means of the motion sensor. The motion sensor can be arranged in or on a roof module of the motor vehicle.

### BACKGROUND AND SUMMARY

The present invention relates to a motion detection system for a motor vehicle and a motor vehicle with the motion detection system.

Sensors and camera systems that provide the vehicle owner with continuous monitoring of their vehicle and its environment via smart phone are known from the state of the art. A corresponding app can provide a 360° view around the vehicle.

To find the person who caused damage to the vehicle, for example after a collision in the parking lot, the vehicle owner would have to turn on the 360° view at the right time by change, which in most cases will probably not happen.

Even if the sensor and camera can be recorded and stored by a 360° view app, the vehicle owner would have to view all the recorded sensor and camera data in order to determine the time of damage and the person who caused the damage. However, this is a very tedious process, which is time-consuming and puts an unnecessary burden on storage capacities.

DE 10 2017 215 489 A1 discloses in this context a parking lot collision detection procedure for a parked vehicle in which at least a motion sensor and an environment recording system are arranged, wherein the parking lot collision detection procedure comprises: detection of a motion of the parked vehicle by the motion sensor; activation of the environment recording system and recording of data on the environment if a motion of the parked vehicle has been detected; performance of a plausibility check of the detected motion, wherein the plausibility check comprises the detection whether an object is located in the vicinity of the vehicle and one of the following actions: stopping recording of the environmental data if no object is detected in the vicinity of the vehicle, or storage and/or transmission of the recorded environmental data if an object has been detected in the vicinity of the vehicle.

In the context of this state of the art, the object of the present invention is to specify a device which is suitable to enhance the state of the art.

This object is achieved by the features of the claimed invention.

According to these claims, the object is achieved by a motion detection system for a parked motor vehicle, wherein the motion detection system has a motion sensor that is equipped to detect a motion of the parked motor vehicle and a control unit coupled to the motion sensor that is configured to emit a control signal when a motion of the parked motor vehicle has been detected by way of the motion sensor. The motion sensor can be arranged in or on a roof module of the motor vehicle.

The motion detection system can be a parking lot collision detection system and/or a system for monitoring tilt. For each of these two systems, a separate control unit can be provided or both functions, that is, the parking lot collision detection function and the tilt (sensor) monitoring, can be implemented in a single control unit.

The roof module can be understood to be a part of the roof or a complete roof of the motor vehicle.

The motion sensor can for example be arranged between an outer skin of the roof module and a roof liner which delimits the roof module from the interior of a passenger compartment.

The motion sensor can be implemented as a 3-axis or a 6-axis acceleration sensor. The latter is also called a gyroscope sensor.

The control unit can for example be an electronic control unit (ECU). The electronic control unit can be an intelligent processor-controlled unit which can for example communicate via a Central Gateway (CGW) with other modules in the motor vehicle and that, via fieldbuses such as CAN bus, LIN bus, MOST bus, or FlexRay and/or via automotive Ethernet, for example together with telematics control units and/or the environmental sensors, can form the on-board vehicle network.

A parked motor vehicle can be understood to be a motor vehicle that is in an idle state, that is, whose velocity is 0 km/h and whose engine is permanently or for an undetermined time has been switched off. Parking is also distinct from stopping, since during parking the motor vehicle is in a non-drivable state.

The motion detection system described above has a series of advantages. For the accurate detection (especially to determine the location and severity of the damage) of a parking lot collision, a central location for the acceleration sensor is advantageous. Furthermore, placing it in the roof module has the advantage that the deflections of the motor vehicle during a parking lot collision are greater in the roof area than near the ground.

Below, possible refinements of the motion detection system described above are described in detail, wherein each of these refinements, alone and/or in combination with one, several, or all of the refinements at least enhances the advantages of the motion detection system described above.

The control unit can be arranged in or on the roof module. This has the advantage that the control unit is arranged near the motion sensor. This permits reduced effort both in the wiring of the motion detection system during assembly of the motor vehicle and in maintenance of the motion detection system during operation of the motor vehicle.

The motion detection system can comprise a environment recording system coupled through the control unit to the motion sensor and the control unit can be configured to emit the control signal to the environment recording system, so that said system records the environmental data corresponding to the environment of the motor vehicle.

This has the advantage that upon detection of motion by the motion sensor, for example in case of a parking lot collision and/or triggered by tilting of the motor vehicle, (sensor) data can be recorded and optionally stored by the environment recording system which permit a cause to be determined for the triggering of the motion detection system.

The environment recording system can comprise a camera for the recording of image data that correspond to the environment of the motor vehicle.

This has the advantage that sensors already installed in the motor vehicle, such as a camera system, can be used together with the motion detection system.

The motion detection system can comprise an information output unit coupled through the control unit to the motion sensor and the control unit can be configured to emit the control signal to the information output unit so that said unit can emit an alarm signal to the environment of the motor vehicle.

The information output unit can also be called an alarm system. The information output can comprise an optical and/or acoustic (warning) signal. This, analogously to the use of the camera, has the advantage that components already installed in the motor vehicle can be used together with the motion detection system.

The motion detection system can comprise an interface coupled through the control unit to the motion sensor and the control unit can be configured to emit the control signal to the interface so that said interface can emit an information to an external data processing device.

The external data processing device can for example be a smart phone which is connected wirelessly through the interface to the motor vehicle. The smart phone can have an app, for example provided by the manufacturer of the motor vehicle, which is configured to inform a user of the smart phone of the triggering of the motion detection system based on the information received.

The use of the interface of the motor vehicle, analogously to the use of the camera and the alarm system, has the advantage that here, too, components already installed in the motor vehicle can be used together with the motion detection system.

The information can comprise the environmental data recorded by the environment recording system.

It is for example imaginable that image data that have been or are being recorded by the camera could be emitted to the smart phone. This can optionally occur in real time and/or the image data can be streamed to the smart phone. This has the advantage that the user of the smart phone can evaluate whether his or her intervention is required due to the triggering of the motion detection system.

The motion sensor can be configured to detect the motion of the parked motor vehicle as a translational motion of the parked motor vehicle and/or a tilt of the parked motor vehicle.

Since the sensors for tilt sensor monitoring and the parking lot collision function have similar requirements-among other things a low idle current, since both functions are also active in the parked state, and a similar trigger mode-the same sensor can be used for both functions. In particular, the control logic and/or control unit for the parking lot collision function and the tilt sensor monitoring can then also be located in the roof module. This has the advantage that only a single sensor is needed, which results in both cost and weight/idle current savings.

The matters described above with reference to possible refinements can be implemented in practice for example as follows, whereby this description is not limiting, just as for publication.

According to a first embodiment, the tilt sensor monitoring can be used to determine or detect the lifting of the vehicle, if an attempt is for example made to remove a wheel of the motor vehicle. In reaction, the emission of an optical and acoustic alarm can take place, optionally in conjunction with notification of the vehicle owner through an app installed on his or her smart phone.

According to a second embodiment, the parking lot collision function can be used to determine or detect the shaking of the motor vehicle in its parked state due to a collision of the motor vehicle with a further or other vehicle. In reaction, the notification of the customer through the app (see above) and the optional recording of a video by the exterior cameras of the motor vehicle can take place, in order to collect evidence for any damages that may occur to the motor vehicle.

A motor vehicle is further provided, wherein the motor vehicle has the motion detection system described above and a roof module.

The motor vehicle can be a personal motor vehicle, in particular an automobile, motorized bicycle or tricycle, or a utility vehicle such as a truck.

The motion sensor can be arranged in the center of the motor vehicle, in particular relative to a longitudinal direction of the motor vehicle and a transverse direction of the motor vehicle.

The above descriptions referring to the motion detection system also apply to the motor vehicle, and vice versa.

An embodiment is described below with reference to FIGS. 1 and 2.

### BRIEF DESCRIPTION OF THE DRAWINGS

FIG. 1 shows a schematic view of a motion detection system of a vehicle.

FIG. 2 shows a schematic side view of a motor vehicle with the motion detection system from FIG. 1.

### DETAILED DESCRIPTION OF THE DRAWINGS

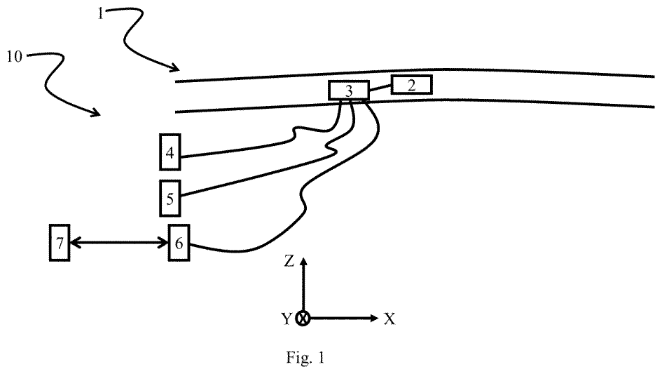

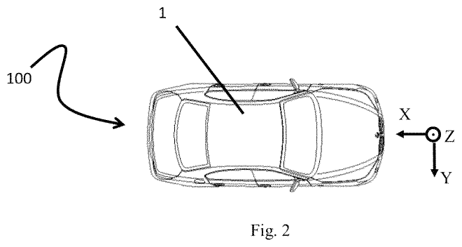

FIGS. 1 and 2 each show a Cartesian coordinate system whose x-axis extends from the front to the back of a motor vehicle 100 and which thereby specifies a vehicular longitudinal direction X. The y-axis vertically intersecting the x-axis runs in a vehicular transverse direction Y, so that the vehicular longitudinal direction X and the vehicular transverse direction Y define a largely horizontal plane. The z-axis vertically intersecting both the vehicular longitudinal direction X and the vehicular transverse direction Y defines a vehicular height direction Z that runs from bottom to top.

FIG. 1 shows the motion detection system 10 in a state installed within motor vehicle 100.

The motion detection system 10 for a parked motor vehicle 100 shown in FIG. 1 comprises a motion sensor 2, which is configured to detect a motion of the parked motor vehicle 100, and a control unit 3 coupled to the motion sensor.

The control unit 3, in its installed state, is connected to an environment recording system 4 of the motor vehicle 100, an alarm system 5 of the motor vehicle, and wirelessly through interface 6 of the motor vehicle 100 to a smart phone 7.

Control unit 3 is configured to emit a control signal to each of the environment recording system 4, alarm system 5, and through interface 6 to the smart phone 7 if a motion of the parked motor vehicle 100 has been detected by way of the motion sensor. Said motion can be a translational motion of the motor vehicle 100 triggered by a parking lot collision, as a result of which the motor vehicle 100 primarily moves along the vehicular longitudinal direction X and/or the vehicular transverse direction Y. Furthermore, said motion can be a tilt of the motor vehicle 100, which could for example be the case if motor vehicle 100 is lifted on one side.

Control unit 3 is configured to use the control signal emitted to the environment recording system 4 to control an environment recording system 4 comprising a camera in such a way that the camera records image data corresponding to an environment of the motor vehicle.

Control unit 3 is further configured to use the control signal emitted to the alarm system 5 to control the alarm system 5 in such a way that it controls an optical and acoustic alarm signal on interface 6 such that it wirelessly emits an information, for example comprising image data recorded by way of the camera, to the smart phone 7 coupled to interface 6.

Both control unit 3 and motion sensor 2, in their installed state, are arranged within the roof module 1 of motor vehicle 100 also shown in FIG. 2, centrally with respect to the vehicular longitudinal direction X and the vehicular transverse direction Y.

This central and, relative to the motor vehicle 100, relatively high arrangement of the motion sensor has-among others-the advantage that the accelerations caused by the parking lot collision can be detected relatively easily, since the deflections are greater in this position than in the case of a lower arrangement of the acceleration sensor 2. Furthermore, only a single acceleration sensor 3 is needed for both tilt monitoring and parking lot collision detection.

### Reference Number List

1 Roof module
2 Acceleration sensor
3 Control unit
4 Environment recording system
5 Alarm system
6 Interface
7 Smart phone
10 Acceleration detection system
100 Motor vehicle
X Vehicular longitudinal direction
Y Vehicular transverse direction
Z Vehicular height direction

1. -10. (canceled).

11. A motion detection system for a parked motor vehicle, the motion detection system comprising:
a motion sensor which is configured to detect a motion of the parked motor vehicle, and
a control unit coupled to the motion sensor, wherein the control unit is configured to emit a control signal upon detection, by the motion sensor, the motion of the parked motor vehicle,
wherein the motion sensor is arrangeable in or on a roof module of the motor vehicle.

12. The motion detection system according to claim 11, wherein the control unit is arrangeable in or on the roof module.

13. The motion detection system according to claim 11, further comprising:
an environment recording system coupled through the control unit to the motion sensor,
wherein the control unit is configured to emit the control signal to the environment recording system, so that the environment recording system can record environmental data corresponding to an environment of the motor vehicle.

14. The motion detection system according to claim 13, wherein the environment recording system comprises a camera for the recording of image data that correspond to the environment of the motor vehicle.

15. The motion detection system according to claim 11, further comprising:
an information output unit coupled through the control unit to the motion sensor,
wherein the control unit is configured to emit the control signal to the information output unit so that the information output unit can emit an alarm signal to an environment of the motor vehicle.

16. The motion detection system according to claim 11, further comprising:
an interface coupled through the control unit to the motion sensor, wherein the control unit is configured to emit the control signal to the interface so that the interface can wirelessly emit information to an external data processing device.

17. The motion detection system according to claim 16, wherein the information comprises environmental data recorded by an environment recording system.

18. The motion detection system according to claim 11, wherein the motion sensor is configured to detect the motion of the parked motor vehicle as a translational motion of the parked motor vehicle and/or a tilt of the parked motor vehicle.

19. A motor vehicle comprising the motion detection system according to claim 11 and the roof module.

20. The motor vehicle according to claim 19, wherein the motion sensor is arranged centrally in the motor vehicle.
